(19) United States
(12) Patent Application Publication
(10) Pub. No.: US 2012/0235801 A1
(43) Pub. Date: Sep. 20, 2012

(54) Wireless apparatus having wake-up function

(75) Inventors: Han Jin Cho, Seoul (KR); Joon Hyung Lim, Gunpo (KR); Gyung Hee Hong, Seoul (KR); Yong Il Kwon, Suwon (KR); Tah Joon Park, Suwon (KR); Myeung Su Kim, Suwon (KR)

(73) Assignee: Samsung Electro-Mechanics Co., Ltd., Suwon (KR)

(21) Appl. No.: 13/067,989

(22) Filed: Jul. 13, 2011

(30) Foreign Application Priority Data
Mar. 15, 2011 (KR) 10-2011-0022652

(51) Int. Cl. G08C 17/00

(52) U.S. Cl. 340/16.1

(57) ABSTRACT

A wireless apparatus having a non-electric power-type wake-up function that operates a wake-up circuit waking-up a microprocessor for communications without power. There is provided a wireless apparatus having a wake-up function, including: a wake-up unit that has a rectifying circuit having elements configured as passive elements and rectifies preset first wireless signals to transmit wake-up signals; and a wireless communications unit that is woken-up by the wake-up signals from the wake-up unit to perform communications using preset second wireless signals, in a sleep mode.

### CROSS-REFERENCE TO RELATED APPLICATIONS

This application claims the priority of Korean Patent Application No. 10-2011-0022652 filed on Mar. 15, 2011, in the Korean Intellectual Property Office, the disclosure of which is incorporated herein by reference.

### BACKGROUND OF THE INVENTION

1. Field of the Invention

The present invention relates to a wireless apparatus, and more particularly, to a wireless apparatus having a wake-up function that wakes-up a microprocessor for communications.

2. Description of the Related Art

Generally, various goods are displayed on display stands in large-scale discount stores or department stores, or the like. Product information or the prices of displayed goods may be displayed above or below products on each display stand.

Product information and price on tags are printed on cards or are marked on products using writing tools.

However, when goods displayed on display stands are changed or the prices of goods are changed, according to the above-mentioned listing method, store managers must replace cards on which the information and prices of goods are listed on a one by one basis while personally circulating around display stands, which is a very cumbersome task and causes a waste of both manpower and time.

In addition, the prices of goods are frequently changed in the case of large-scale discount stores, and, as a result, it is difficult for store mangers to rapidly replace memo pads one by one while circulating around display stands.

Therefore, a two-way wireless electronic information display apparatus that may transmit and receive product information and the prices of the corresponding goods by a wireless communications method, such as an infrared communications method or a radio frequency (RF) communications method, has been proposed.

Meanwhile, the wireless electronic information display apparatus includes a wireless communications module for wireless communications and a liquid crystal display (LCD) module for displaying electronic information. In order to use the wireless communications module and the liquid crystal display module, the wireless electronic information display apparatus has generally used a battery. However, since the power capacity of a battery is limited, the wireless communications module performs communications by using a sleep mode, which repeatedly wakes-up the wireless communications module at predetermined times, in order to increase the use time of the battery. As described above, the method for increasing the use time of the battery in the wireless communications module increases the time of the sleep mode, but may not perform communications in the sleep mode. Therefore, it is difficult to cope with situations in which rapid communications are required.

### SUMMARY OF THE INVENTION

An aspect of the present invention provides a wireless apparatus having a non-electric power-type wake-up function that operates a wake-up circuit waking-up a microprocessor for communications without power.

According to an exemplary embodiment of the present invention, there is provided a wireless apparatus having a wake-up function, including: a wake-up unit that has a rectifying circuit having elements configured as passive elements and rectifies preset first wireless signals to transmit wake-up signals; and a wireless communications unit that is woken-up by the wake-up signals from the wake-up unit to perform communications using preset second wireless signals, in a sleep mode.

The wake-up unit may include: a rectifying unit that rectifies the first wireless signals; and a detector unit that outputs the wake-up signals when the signals rectified from the rectifying unit satisfy a preset reference level.

The rectifying unit may have at least one rectifier having elements configured as passive elements, wherein the at least one rectifier may include: a first capacitor and a first diode that level-shift DC components of the first wireless signal; and a second capacitor and a second diode that detect peak components of the level-shifted first wireless signal.

The first capacitor may have one end and the other end, and the one end of the first capacitor may receive the first wireless signals, the second capacitor may have one end and the other end, and the other end of the second capacitor may be connected to a ground, the second diode may have an anode connected to the other end of the first capacitor and a cathode connected to the one end of the second capacitor, and the first diode may have a cathode connected to the other end of the first capacitor.

The rectifying unit may have a plurality of rectifiers connected to each other in parallel, each of the plurality of rectifiers may include the first and second capacitors and the first and second diodes, and the anode of each first diode of the plurality of rectifiers may be connected to the cathode of the second diode of the rectifier in a previous stage and the anode of the first diode of the rectifier in an initial stage may be connected to a ground.

The first capacitor may have one end and the other end, and the one end of the first capacitor may receive the first wireless signals, the second capacitor may have one end and the other end, and the other end of the second capacitor may be connected to the ground, the first diode may have an anode connected to the other end of the first capacitor and a cathode connected to the one end of the second capacitor, and the second diode may have a cathode connected to the other end of the first capacitor.

The rectifying unit may have a plurality of rectifiers connected to each other in parallel, each of the plurality of rectifiers may include the first and second capacitors and the first and second diodes, and the anode of each second diode of the plurality of rectifiers may be connected to the cathode of the first diode of the rectifier in a previous stage and the anode of the second diode of the rectifier in an initial stage may be connected to the ground.

The first and second diodes may be an N-type metal-oxide-semiconductor field-effect transistor (MOSFET).

The detector unit may include first and second inverters that are connected to each other in parallel to invert the rectified first wireless signals and an N-type transistor that is connected between the first inverter and the ground and is driven by being supplied with preset bias power.

The first and second inverters may each include two metal-oxide-semiconductor field-effect transistors that are connected to each other in series and have different polarities.

The N-type transistor may be an N-type metal-oxide-semiconductor field-effect transistor.

The wake-up unit may further include a protection unit that limits levels of the first wireless signals rectified from the rectifying.

The protection unit may include the N-type metal-oxide-semiconductor field-effect transistor conducted when the levels of the first wireless signals rectified from the rectifying unit are at a preset reference level or more.

The wireless communications unit may include: a communications unit that performs wireless communications using the second wireless signals; and a control unit that is woken-up in response to the wake-up signals to process information transmitted from the communications unit.

The use frequency bands of the first wireless signals may be equal to or different from the use frequency bands of the second wireless signals.

The wireless apparatus having a wake-up function may further include a display unit that displays the information from the wireless communications unit.

The wireless apparatus having a wake-up function may further include a low-noise amplifier that amplifies the first wireless signals and transfers the amplified first wireless signals to the wake-up unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram schematically showing a wireless apparatus according to an exemplary embodiment of the present invention;

FIG. 2 is a circuit diagram schematically showing an aspect of a rectifying unit of a wake-up unit adopted in the wireless apparatus according to the exemplary embodiment of the present invention;

FIG. 3 is a circuit diagram schematically showing another aspect of a rectifying unit of a wake-up unit adopted in the wireless apparatus according to the exemplary embodiment of the present invention;

FIG. 4 is a circuit diagram schematically showing an aspect of the wake-up unit adopted in the wireless apparatus according to the exemplary embodiment of the present invention; and

FIGS. 5A and 5B are diagrams showing each aspect of rectified first wireless signals according to an exemplary embodiment of the present invention.

### DETAILED DESCRIPTION OF THE PREFERRED EMBODIMENT

Exemplary embodiments of the present invention will now be described in detail with reference to the accompanying drawings such that they could be easily practiced by those having skill in the art to which the present invention pertains.

However, in describing the exemplary embodiments of the present invention, detailed descriptions of well-known functions or constructions will be omitted so as not to obscure the description of the present invention with unnecessary detail.

In addition, like reference numerals denote like elements throughout the drawings.

Unless explicitly described to the contrary, the word “comprise” and variations such as “comprises” or “comprising,” will be understood to imply the inclusion of stated elements but not the exclusion of any other elements.

Hereinafter, exemplary embodiments of the present invention will be described with reference to the accompanying drawings.

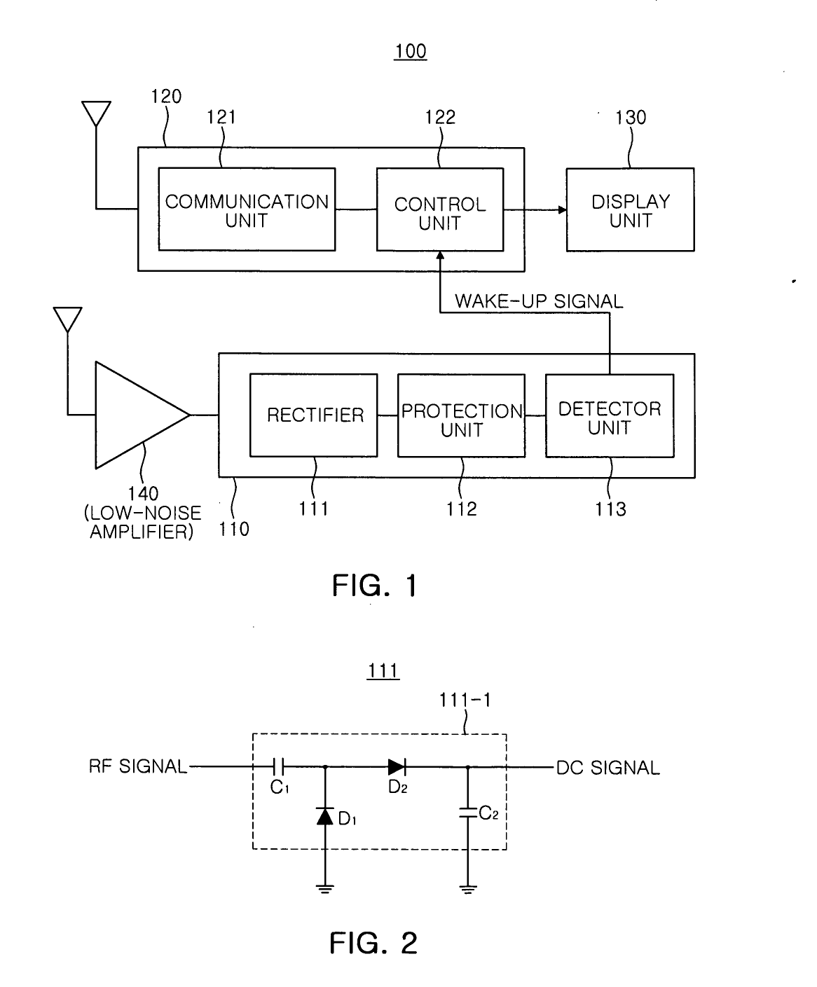

FIG. 1 is a configuration diagram schematically showing a wireless apparatus according to an exemplary embodiment of the present invention.

Referring to FIG. 1, a wireless apparatus 100 according to the exemplary embodiment of the present invention may include a wake-up unit 110 and a wireless communications unit 120 and may further include a display unit 130 and a low noise amplifier 140.

The wake-up unit 110 may receive preset first wireless signals and rectifies the received first wireless signals, and, when the rectified first wireless signals satisfy a preset reference level, may generate wake-up signals.

To this end, the wake-up unit 110 may include a rectifying unit 111 and a detector unit 113 and may further include a protection unit 112.

The rectifying unit 111 may receive AC signals, that is, the first wireless signals, and rectifies the received first wireless signals into DC signals. The detector unit 113 may output the wake-up signals when the first wireless signals rectified from the rectifying unit 111 satisfy the preset reference level.

The protection unit 112 may limit signal levels of the first wireless signals rectified from the rectifying unit 111 to protect the detector unit 113.

The wireless communications unit 120 may be woken-up according to wake-up signals from the wake-up unit 110 in a sleep mode to perform a preset wireless communications operation.

To this end, the wireless communications unit 120 may include a communications unit 121 and a control unit 122.

The communications unit 121 may perform communications using a preset second wireless signals and the control unit 122 may process information transmitted through the second wireless signals from the communications unit 121.

Meanwhile, the control unit 122 may perform a control to display the information transmitted through the second wireless signals and the display unit 130 may display the information to be recognized from the outside. For example, in the case in which the wireless apparatus 100 according to the exemplary embodiment of the present invention is adopted in an electrical shelf label (ESL) apparatus, when price information is transmitted through the second wireless signals, the control unit 122 may perform a control to display the prices transmitted to the display unit 130 and the display unit 130 may display the transmitted prices to be recognized from the outside.

In this case, a use frequency band of the first wireless signals and a use frequency band of the second wireless signals may be different from each other or may be equal to each other.

The low-noise amplifier 140 may amplify the signal levels of the first wireless signals and transmit the amplified first wireless signals to the wake-up unit 110.

FIG. 2 is a circuit diagram schematically showing an aspect of a rectifying unit of a wake-up unit adopted in the wireless apparatus according to the exemplary embodiment of the present invention.

Referring to FIG. 2, the rectifying unit 110 may include at least one rectifier 111-1 having elements configured as passive elements, wherein the at least one rectifier 111-1 may include first and second capacitors C1 and C2 and first and second diodes D1 and D2.

The first capacitor C1 and the first diode D1 level-shift DC components of the input first wireless signals and the second capacitor C2 and the second diode D2 detect peak components of the level-shifted first wireless signals.

That is, the first capacitor C1 may be charged by a difference between a magnitude in negative half-period signals among the first wireless signals and a drop voltage of the first diode D1, and the second capacitor C2 and the second diode D2 may detect the peak components of the charged voltage levels. In positive half-period signals among the first wireless signals, the second capacitor C2 may be charged by a difference between a magnitude in the positive half-period signals and a drop voltage of the second diode D2 through the second diode D2, and when the drop voltages of the first and second diodes D1 and D2 are ideally equal to each other, the rectified signals output from at least one rectifier 111-1 may be equal to twice the difference between the magnitude of the half-period signals of the first wireless signals and the drop voltage of the diodes. In addition, for example, when a plurality of rectifiers, that is, N rectifiers, are provided, the rectified signals output may be 2N times the difference between the magnitude in the half-period signals of the first wireless signals and the drop voltage of the diodes.

The first capacitor C1 has two ends. One end of the first capacitor C1 may receive the first wireless signals and the other end thereof may be connected to an anode of the second diode D2 and a cathode of the first diode D1.

The second capacitor C2 has two ends. One end of the second capacitor C2 may be connected to a cathode of the second diode D2 and the other end of the second capacitor C2 may be connected to a ground.

The anode of the first diode D1 may be connected to a ground and the cathode of the first diode D1 may be connected to the other end of the first capacitor C1.

The anode of the second diode D2 may be connected to the other end of the first capacitor C1 and the cathode of the second diode D2 may be connected to one end of the second capacitor C2.

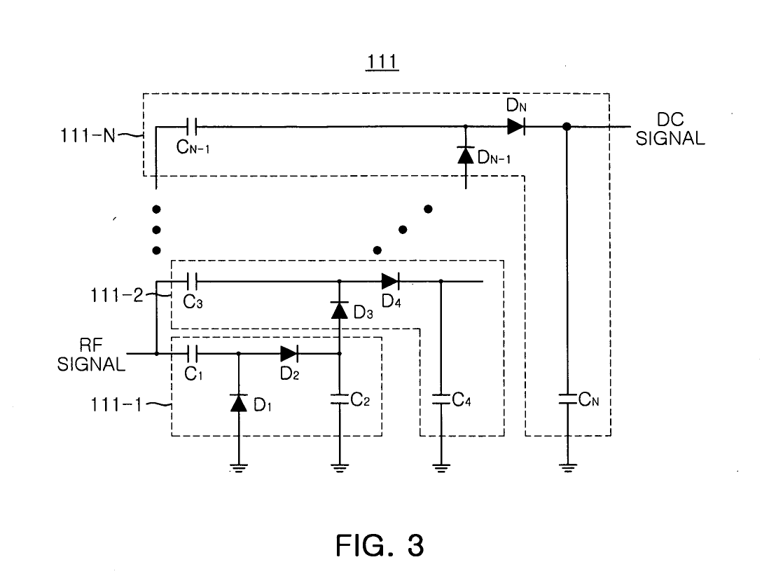

FIG. 3 is a circuit diagram schematically showing another aspect of a rectifying unit of a wake-up unit adopted in the wireless apparatus according to the exemplary embodiment of the present invention.

Referring to FIG. 3, the rectifying unit 111 may include the plurality of rectifiers 111-1, 111-2, . . . , 111-N that are connected to each other in parallel and each of the plurality of rectifiers 111-1, 111-2, . . . , 111-N may include the first and second capacitors C1, C2, C3, C4, . . . , CN-1, and CN and the first and second diodes D1, D2, D3, D4, . . . , DN-1, and DN, as shown in FIG. 2. The functions and the connection relationship of the first and second capacitors C1, C2, C3, C4, . . . , CN-1, and CN and the first and second diodes D1, D2, D3, D4, . . . , DN-1, and DN are similar to the description of FIG. 2, so a detailed description thereof will therefore be omitted. However, the anode of the second diodes D4 and DN of the second to N-th rectifiers 111-2, . . . ,111-N may be connected to the cathode of the second diode of the rectifier in a previous stage and the anode of the first diode D1 of the first rectifier 111-1 may be connected to the ground.

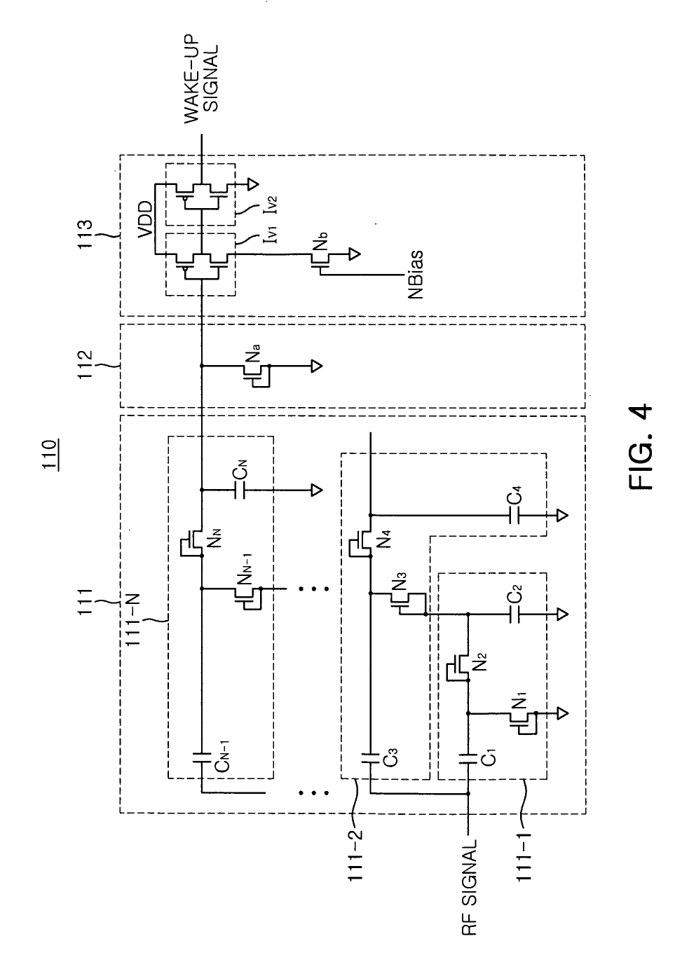

FIG. 4 is a circuit diagram schematically showing an aspect of the wake-up unit adopted in the wireless apparatus according to the exemplary embodiment of the present invention.

Referring to FIG. 4, the rectifying unit 111 of the wake-up unit 110 may include the plurality of rectifiers 111-1, 111-2, . . . , 113-N that are connected to each other in parallel, as shown in FIG. 3 and may include the first and second capacitors C1, C2, C3, C4, . . . , CN-1, and CN and the first and second diodes D1, D2, D3, D4, . . . , DN-1, and DN. However, the first and second diodes D1, D2, D3, D4, . . . , DN-1, and DN may be configures as metal-oxide-semiconductor field-effect transistors (MOSFET) N1, N2, N3, N4, . . . , NN-1, NN. The functions and the connection relationship of the first and second capacitors C1, C2, C3, C4, . . . , CN-1, and CN and first and second diodes N1, N2, N3, N4, . . . , NN-1, NN are similar to the description of FIG. 3 and the detailed description thereof will be omitted.

The protection unit 112 may include one N-type metal-oxide-semiconductor field-effect transistor (Na). The one N-type metal-oxide-semiconductor field-effect transistor (Na) may be connected between a signal transfer line between the rectifying unit 111 and the detector unit 113 and the ground to be conducted when the levels of the first wireless signals rectified from the rectifying unit 111 is the preset level or more, thereby protecting the detector unit 113.

The detector unit 113 may include first and second inverters Iv1 and Iv2 that are connected to each other in parallel and one N-type metal-oxide-semiconductor field-effect transistor (Nb).

The first and second inverters Iv1 and Iv2 may be respectively configured to include two metal-oxide-semiconductor field-effect transistors that are connected to each other in series and have opposite polarities, wherein gates of two metal-oxide-semiconductor field-effect transistors may be connected in common.

The one N-type metal-oxide-semiconductor field-effect transistor (Nb) may be operated by being supplied with preset bias power NBias and may be connected between the first inverter Iv1 and the ground.

Meanwhile, the detector unit 113 may transmit the wake-up signals that wake-up the control unit 122 when the rectified first wireless signals satisfy the preset reference.

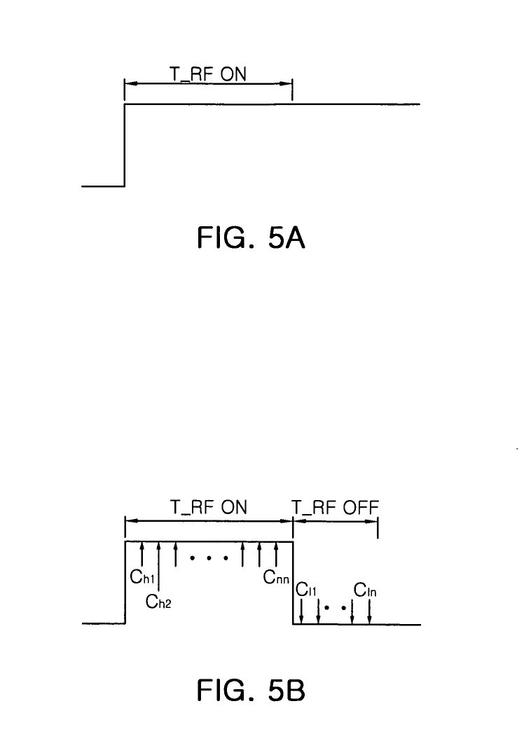

FIGS. 5A and 5B are diagrams showing each aspect of the rectified first wireless signal according to an exemplary embodiment of the present invention.

Referring to FIG. 5A, when a rectified first wireless signal T_RFON has a predetermined level or more for a predetermined time, the detector unit 113 may transmit the wake-up signals that wake-up the control unit 122. The reason of waiting for a predetermined time is to perform a normal operation of transmitting the wake-up signals even when noise or instantaneous interference signals from other devices are input.

In addition, referring to FIG. 5B, when a rectified first wireless signal T_RF ON has a predetermined level or more for a predetermined time and then, a rectified first wireless signal T_RF OFF has a predetermined level or less for a predetermined time, the detector unit 113 may transmit the wake-up signals that wake-up the control unit 122. Clocks used in the sleep mode may be counted and set for the predetermined time, such that the wake-up operation of the wireless communications unit 120 may be performed without interference even when the continuous interference signals equal to or similar to the use frequency bands of the first wireless signals are input.

As set forth above, the exemplary embodiment of the present invention operates the wake-up circuit to wake-up the microprocessor for communications without power, thereby extending the use time of the battery thereof.

While the present invention has been shown and described in connection with the exemplary embodiments, it will be apparent to those skilled in the art that modifications and variations can be made without departing from the spirit and scope of the invention as defined by the appended claims.

What is claimed is:

1. A wireless apparatus having a wake-up function, comprising:
a wake-up unit including a rectifying circuit having elements configured as passive elements, the wake-up unit rectifying preset first wireless signals to transmit wake-up signals; and
a wireless communications unit woken-up by the wake-up signals from the wake-up unit to perform communications using preset second wireless signals, in a sleep mode.

2. The wireless apparatus having a wake-up function of claim 1, wherein the wake-up unit includes:
a rectifying unit that rectifies the first wireless signals; and
a detector unit that outputs the wake-up signals when the signals rectified from the rectifying unit satisfy a preset reference level.

3. The wireless apparatus having a wake-up function of claim 2, wherein the rectifying unit has at least one rectifier configured as passive elements, and
the at least one rectifier includes:
a first capacitor and a first diode that level-shift DC components of the first wireless signal; and
a second capacitor and a second diode that detect peak components of the level-shifted first wireless signal.

4. The wireless apparatus having a wake-up function of claim 3, wherein the first capacitor has one end and the other end, and the one end of the first capacitor receives the first wireless signals,
the second capacitor has one end and the other end, and the other end of the second capacitor is connected to a ground,
the second diode has an anode connected to the other end of the first capacitor and a cathode connected to the one end of the second capacitor, and
the first diode has a cathode connected to the other end of the first capacitor.

5. The wireless apparatus having a wake-up function of claim 4, wherein the rectifying unit has a plurality of rectifiers connected to each other in parallel,
each of the plurality of rectifiers includes the first and second capacitors and the first and second diodes, and
an anode of each first diode of the plurality of rectifiers is connected to a cathode of a second diode of the rectifier in a previous stage and an anode of the first diode of the rectifier in an initial stage is connected to a ground.

6. The wireless apparatus having a wake-up function of claim 3, wherein the first and second diodes are an N-type metal-oxide-semiconductor field-effect transistor (MOSFET).

7. The wireless apparatus having a wake-up function of claim 2, wherein the detector unit includes:
first and second inverters that are connected to each other in parallel to invert the rectified first wireless signals; and
an N-type transistor that is connected between the first inverter and the ground and is driven by being supplied with preset bias power.

8. The wireless apparatus having a wake-up function of claim 7, wherein the first and second inverters each include two metal-oxide-semiconductor field-effect transistors that are connected to each other in series and have different polarities.

9. The wireless apparatus having a wake-up function of claim 7, wherein the N-type transistor is an N-type metal-oxide-semiconductor field-effect transistor.

10. The wireless apparatus having a wake-up function of claim 2, wherein the wake-up unit further includes a protection unit that limits levels of the first wireless signals rectified from the rectifying unit.

11. The wireless apparatus having a wake-up function of claim 10, wherein the protection unit includes the N-type metal-oxide-semiconductor field-effect transistor conducted when the levels of the first wireless signals rectified from the rectifying unit are at a preset reference level or more.

12. The wireless apparatus having a wake-up function of claim 1, wherein the wireless communications unit includes:
a communications unit that performs wireless communications using the second wireless signals; and
a control unit that is woken-up in response to the wake-up signals to process information transmitted from the communications unit.

13. The wireless apparatus having a wake-up function of claim 1, wherein use frequency bands of the first wireless signals are different from use frequency bands of the second wireless signals.

14. The wireless apparatus having a wake-up function of claim 1, wherein the use frequency bands of the first wireless signals are equal to the use frequency bands of the second wireless signals.

15. The wireless apparatus having a wake-up function of claim 1, further comprising a display unit displaying the information from the wireless communications unit.

16. The wireless apparatus having a wake-up function of claim 1, further comprising a low-noise amplifier amplifying the first wireless signals and transferring the amplified first wireless signals to the wake-up unit.
